(19) United States
(12) Patent Application Publication
(10) Pub. No.: US 2020/0363684 A1
(43) Pub. Date: Nov. 19, 2020

(54) PRISM SHEET, BACKLIGHT MODULE, DISPLAY DEVICE, AND MANUFACTURING METHOD FOR PRISM SHEET

(71) Applicants: BEIJING BOE DISPLAY TECHNOLOGY CO., LTD., Beijing (CN); BOE TECHNOLOGY GROUP CO., LTD., Beijing (CN)

(72) Inventor: Zihao ZHAO, Beijing (CN)

(21) Appl. No.: 16/639,880

(22) PCT Filed: Mar. 12, 2019
(86) PCT No.: PCT/CN2019/077844

§ 371 Date: Feb. 18, 2020

(30) Foreign Application Priority Data
Mar. 16, 2018 (CN) 201810220386.5

(51) Int. Cl. G02F 1/13357; G02B 5/04

(52) U.S. Cl. CPC G02F 1/133606; G02F 2001/133607; G02F 1/133603; G02B 5/045

(57) ABSTRACT

A prism sheet, a backlight module, a display and a preparation method of the prism sheet are provided. The prism sheet includes a base layer and a prism layer located on a surface of a first side of the base layer, holes are provided inside the base layer, so that light received from a second side of the base layer reaches the prism layer through the holes, and the first side of the base layer and the second side of the base layer are opposite to each other.

The present application claims priority of the Chinese Patent Application No. 201810220386.5, filed on Mar. 16, 2018, the disclosure of which is incorporated herein by reference in its entirety as part of the present application.

### TECHNICAL FIELD

Embodiments of the present disclosure relate to a prism sheet, a backlight module, a display, and a preparation method of the prism sheet.

### BACKGROUND

A backlight module is one of main components of a liquid crystal display. The backlight module is used to diffuse light emitted by a point light source or a line light source, thereby causing the point light source or the line light source to be a surface light source, thus providing sufficient brightness and uniformly distributed light sources for a liquid crystal panel of the liquid crystal display, so that the liquid crystal panel normally displays images. The backlight module serves as a light source and has advantages, such as high brightness, long service life, uniform light emission, etc.

### SUMMARY

Embodiments of the present disclosure provide a prism sheet, a backlight module, a display, and a preparation method of the prism sheet, through providing holes on a base layer of the prism sheet, the light loss caused by the base layer is reduced, the light transmission efficiency of a light source is improved, furthermore, the brightness of the backlight source is improved, and the overall brightness of a display panel is improved.

Some embodiments of the present disclosure provide a prism sheet, and the prism sheet comprises: a base layer and a prism layer on a surface of a first side of the base layer; and holes are provided inside the base layer, so that light received from a second side of the base layer reaches the prism layer through the holes, and the first side of the base layer and the second side of the base layer are opposite to each other.

For example, in the prism sheet provided by some embodiments of the present disclosure, the prism layer comprises a plurality of prisms, and at least one hole is provided at a position, corresponding to each prism of the plurality of prisms, in the base layer.

For example, in the prism sheet provided by some embodiments of the present disclosure, in a case where one hole is provided at the position, corresponding to each prism, in the base layer, an end surface, that is close to the prism layer, of a hole corresponding to a prism coincides with a bottom surface of the prism.

For example, in the prism sheet provided by some embodiments of the present disclosure, the end surface, which is close to the prism layer, of the hole corresponding to the prism completely coincides with the bottom surface of the prism.

For example, in the prism sheet provided by some embodiments of the present disclosure, in the case where at least two holes are provided at the position, corresponding to each prism, in the base layer, end surfaces, which are close to the prism layer, of the at least two holes corresponding to one prism coincide with a bottom surface of the prism.

For example, in the prism sheet provided by some embodiments of the present disclosure, the end surfaces, which are close to the prism layer, of the at least two holes corresponding to the prism completely coincides with the bottom surface of the prism.

For example, in the prism sheet provided by some embodiments of the present disclosure, at least one of the holes is a blind hole, and an opening of the blind hole is located on the first side of the base layer or on the second side of the base layer.

For example, in the prism sheet provided by some embodiments of the present disclosure, an area of an end surface, which is close to the first side of the base layer, of each hole is larger than an area of an end surface, which is close to the second side of the base layer, of each hole.

For example, in the prism sheet provided by some embodiments of the present disclosure, each hole is a tapered hole, and a radius of an end surface, which is close to the first side of the base layer, of each hole is larger than a radius of an end surface, which is close to the second side of the base layer, of each hole.

For example, in the prism sheet provided by some embodiments of the present disclosure, the radius of the end surface, which is close to the first side of the base layer, of each hole ranges from 60 to 80 nanometers, and the radius of the end surface, which is close to the second side of the base layer, of each hole ranges from 30 to 40 nanometers.

For example, in the prism sheet provided by some embodiments of the present disclosure, a distance between end surfaces, which are close to the second side of the base layer, of any two adjacent holes is not less than 100 nanometers.

Some embodiments of the present disclosure also provide a backlight module, which comprises a light source and the prism sheet according to any one of the above embodiments, and the light source is configured to provide the light for the prism sheet.

For example, in the backlight module provided by some embodiments of the present disclosure, the light source is located on the second side of the base layer of the prism sheet.

For example, in the backlight module provided by some embodiments of the present disclosure, the light source is a light-emitting diode light source.

Some embodiments of the present disclosure also provide a display, which comprises the backlight module according to any one of the above embodiments.

Some embodiments of the present disclosure also provide a preparation method of the prism sheet according to any one of the above embodiments, and the preparation method comprises: preparing the holes in the base layer of the prism sheet, so that the light received from the second side of the base layer reaches the prism layer through the holes.

For example, the preparation method of the prism sheet provided by some embodiments of the present disclosure further comprises: coating a curable adhesive on the base layer provided with the holes or the prism layer, and curing the curable adhesive.

For example, in the preparation method of the prism sheet provided by some embodiments of the present disclosure, the curable adhesive is an ultraviolet curable adhesive.

Additional aspects and advantages of the present disclosure will be set forth in part in the following description, and will become apparent from the following description, or may be learned through practice of the present disclosure.

### BRIEF DESCRIPTION OF THE DRAWINGS

In order to clearly illustrate the technical solutions of the embodiments of the present disclosure, the drawings of the embodiments will be briefly described in the following; and it is obvious that the described drawings are only related to some embodiments of the present disclosure and thus are not limitative to the present disclosure.

FIG. 1A is a structural schematic diagram of a prism sheet provided by some embodiments of the present disclosure;

FIG. 1B is a structural schematic diagram of another prism sheet provided by some embodiments of the present disclosure;

FIG. 1C is a structural schematic diagram of still yet prism sheet provided by some embodiments of the present disclosure;

FIG. 2 is a structural schematic diagram of a prism sheet;

FIG. 3 is a perspective structural schematic diagram of a prism sheet provided by some embodiments of the present disclosure;

FIG. 4 is a schematic diagram of an arrangement mode of holes inside a base layer of a prism sheet provided by some embodiments of the present disclosure;

FIG. 5 is a schematic diagram of another arrangement mode of holes inside a base layer of a prism sheet provided by some embodiments of the present disclosure;

FIG. 6 is a longitudinal sectional schematic diagram of a prism sheet provided by some embodiments of the present disclosure;

FIG. 7 is a perspective structural schematic diagram of a base layer of a prism sheet provided by some embodiments of the present disclosure; and

FIG. 8 is a perspective structural schematic diagram of another prism sheet provided by some embodiments of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “comprise,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may comprise an electrical connection, directly or indirectly. “On,” “under,” “right,” “left” and the like are only used to indicate relative position relationship, and when the position of the object which is described is changed, the relative position relationship may be changed accordingly.

Embodiments of the present disclosure are described in detail below, examples of the embodiments are illustrated in the accompanying drawings, the same or similar reference numerals refer to the same or similar elements or elements having the same or similar functions throughout. The embodiments described below with reference to the accompanying drawings are exemplary and are only for the purpose of explaining the present disclosure and should not be construed as limiting the present disclosure.

Those skilled in the art should understand that the singular forms “a”, “an”, and “the” as used herein may also include plural forms unless specifically stated. It should be further understood that the term “include/comprise” as used in the specification of this present disclosure refers to the presence of features, integers, steps, operations, elements, and/or components, but does not preclude the presence or addition of one or more other features, integers, steps, operations, elements, components, and/or combination thereof. As used herein, the term “and/or” includes all or any of the elements and all combinations of one or more associated listed items.

Those skilled in the art will understand that unless otherwise defined, all terms (including technical terms and scientific terms) used herein have the same meaning as commonly understood by those of ordinary skill in the art to which this present disclosure belongs. It should also be understood that terms, such as the terms defined in general dictionaries, should be understood to have meanings consistent with those in the context of the prior art, and will not be interpreted in idealized or overly formal meanings unless specifically defined as herein.

Most backlight modules use a prism film (also called a prism sheet) to improve a front-view brightness (or axial brightness) of the backlight module. The prism film comprises a transparent plastic film and a prism layer, the prism layer uniformly and neatly covers a surface of the plastic film, the prism layer is used for improving an angular distribution of light, and light emitted from a diffusion sheet in the backlight module and uniformly diverging to various angles can be converged to an axial angle, that is, a front-view angle, so that the axial brightness can be improved without increasing a total luminous flux, which is emitted.

High brightness, thinness, low power consumption, low cost, and high quality have always been the goals pursued by an entire liquid crystal panel industry. However, the reality is that an efficiency of converting the line light source emitted from the point light source or the line light source (e.g. a lamp bar) into the surface light source after passing through a light guide plate and various film materials is generally low, resulting in large power consumption, low brightness, and thick overall of the backlight module panel, seriously affecting the display effect of the display panel. Therefore, how to further improve the brightness of a backlight source on the premise of meeting requirements of thinning and low power consumption has become an urgent problem for those skilled in this field.

Various embodiments of the present disclosure are described in detail below.

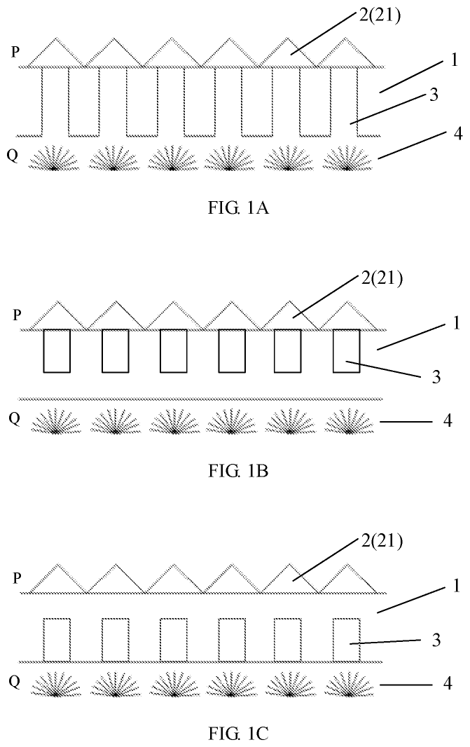

Some embodiments of the present disclosure provide a prism sheet, a structural schematic diagram of the prism sheet is shown in FIG. 1A, the prism sheet may include a base layer 1 and a prism layer 2 located on a surface of a first side P of the base layer 1, and holes 3 are provided inside the base layer 1, so that light received from a second side Q of the base layer 1 can reach the prism layer 2 through the holes 3.

For example, the base layer 1 may be made of a base material, such as PET (Polyethylene terephthalate, polyethylene terephthalate plastic).

For example, the first side P of the base layer 1 and the second side Q of the base layer 1 may be two sides opposite to each other.

For example, as shown in FIGS. 1A-1B, a light source 4 may be disposed on the second side Q of the base layer 1, i.e., the light source 4 and the prism layer 2 are disposed on two sides of the base layer 1, respectively. The light source 4 may provide the light to the second side Q of the base layer 1 of the prism sheet.

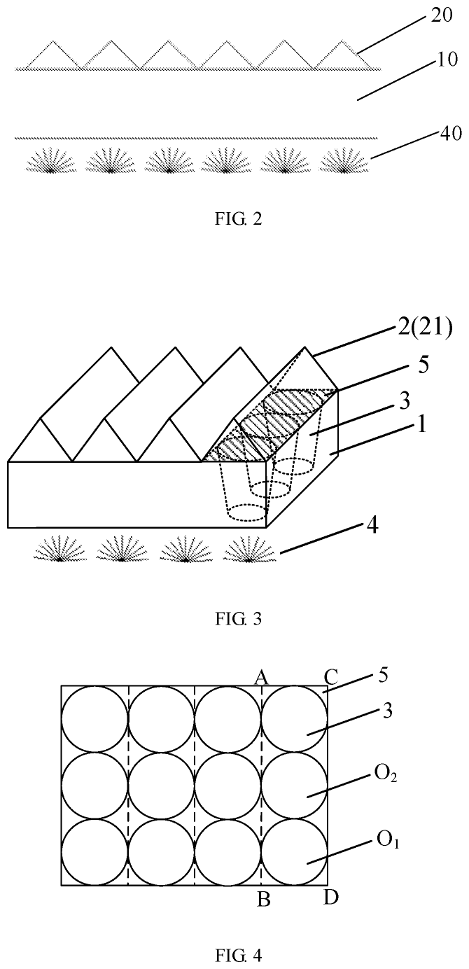

FIG. 2 is a structural schematic diagram of a prism sheet. As shown in FIG. 2, a prism sheet in a backlight module includes a base layer 10 and a prism layer 20. The prism layer 2 covers the base layer 1 and has a plurality of tiny prisms 21. After light emitted from a light source 40 passes through the base layer 10, the light is converged by the prism layer 20 and then emitted. The base layer 10 has a certain attenuation effect on the light passing through the base layer 10, thereby causing light loss, and resulting in that the light finally reaching the prism layer 20 has the low brightness.

In the prism sheet provided by the embodiment of the present disclosure, by providing the holes 3 in the base layer 1 of the prism sheet, at least part of the light emitted by the light source 4 can reach the prism layer 2 through the holes 3, thereby reducing the light loss caused by the light passing through the base layer 1 of the prism sheet, further improving the light transmission efficiency of the light source 4, and finally improving the overall brightness of the display panel; and on the other hand, because the holes 3 are distributed in the base layer 1, the internal stress of the prism sheet is released, so that the prism sheet is not easy to deform in extreme environment, thereby improving the quality of the prism sheet.

For example, as shown in FIG. 1A, in some embodiments, all the holes 3 penetrate through the base layer 1, i.e., all the holes 3 are through holes, so that at least part of the light emitted from the light source 4 can directly reach the prism layer 2 through the holes 3 to avoid light loss caused by the light passing through the base layer 1 of the prism sheet.

For example, in other embodiments, at least one of the holes 3 is a blind hole, in light paths of at least part of the light, emitted by the light source 4, from the second side Q to the first side P of the base layer 1, at least part of the light paths is located in the holes 3, and there is no light loss in a case where the light passes through the holes 3, so that the light loss caused by the light passing through the base layer 1 of the prism sheet can be reduced.

For example, as shown in FIGS. 1B and 1C, all the holes 3 are blind holes. However, the present disclosure is not limited to this case. One part of the holes 3 may be the through holes and the other part of the holes 3 may be the blind holes. The present disclosure is not specifically limited to the number and the distribution mode of the through holes and the number and the distribution mode of the blind holes.

For example, as shown in FIG. 1B, in some examples, an opening of the blind hole is located on the first side P of the base layer 1; and as shown in FIG. 1C, in other examples, an opening of the blind hole is located on the second side Q of the base layer 1. It should be noted that in a case where the base layer 1 includes a plurality of blind holes, depths of respective blind holes may be the same, or at least part of the blind holes may have different depths. In addition, the openings of the plurality of blind holes may be located on the same side, for example, the first side P of the base layer 1 or the second side Q of the base layer 1; alternatively, the openings of some of the blind holes may be located on the first side P of the base layer 1, and the openings of some of the blind holes may be located on the second side Q of the base layer 1.

For example, surfaces of the holes 3 may be smooth. But the embodiments of the present disclosure are not limited to this case, at least part of the surfaces of the holes 3 may be rough.

FIG. 3 is a perspective structural schematic diagram of a prism sheet provided by some embodiments of the present disclosure; and FIG. 4 is a schematic diagram of an arrangement mode of holes inside a base layer of a prism sheet provided by some embodiments of the present disclosure. FIG. 4 corresponds to a cross-sectional view of an intersection surface of the base layer 1 and the prism layer 2 in FIG. 3, and a region between two adjacent dashed lines in FIG. 4 corresponds to a bottom surface 5 of one prism 21 (i.e., a shaded portion in the prism 21 in FIG. 3).

For example, in a specific embodiment, the prism layer 2 includes a plurality of prisms 21, for example, the prisms in the prism layer 2 may be triangular prisms, pentaprisms, Powell lenses, pyramid prisms, etc. At least one hole 3 is provided at a position, corresponding to each prism 21 of the prism layer 2, in the base layer 1. It should be noted that in the examples as shown in FIGS. 3 and 4, it is only shown that the prism layer 2 includes three prisms 21 arranged side by side and each prism 21 corresponds to three holes 3. But the present disclosure is not limited to this case. The type, shape, number, and arrangement mode of prisms 21 in the prism layer 2 can be set according to specific application requirements, and the number and arrangement mode of the holes corresponding to each prism 21 can also be set according to specific application requirements.

For example, as shown in FIGS. 3 and 4, in some embodiments, the prism layer 2 includes a plurality of triangular prisms, i.e., each prism 21 is a triangular prism, and the bottom surface of each prism 21 is rectangular. Each prism 21 corresponds to a plurality of holes 3, and the plurality of holes 3 are distributed in a row in the base layer 1 at the position of the prisms 21 corresponding to the plurality of holes 3. Each hole 3 of the holes 3 is only distributed in a region corresponding to the bottom surface 5 of one prism 21, that is, an end surface, which is close to the prism layer 21, of each hole 3 is located inside the bottom surface 5 of the corresponding prism 21.

In order to further reduce the light loss caused by light passing through the base layer 1, an area of the end surface, which is close to the bottom surface 5 of the prism 21, of the hole 3 should be as large as possible, so that more light passes through the hole 3 to reach the prism layer 2, the light loss can be further reduced. For example, in the example as shown in FIGS. 3 and 4, in a case where the end surface of the hole 3 is circular, the end surface of the hole 3 may be tangent to two longer edges of the bottom surface 5 of the prism 21, and the adjacent two holes 3 may also be tangent to each other. As shown in FIG. 4, a hole Oi is tangent to both an AB edge and a CD edge of the bottom surface 5 of the prism 21, and the hole Oi is tangent to a hole 02.

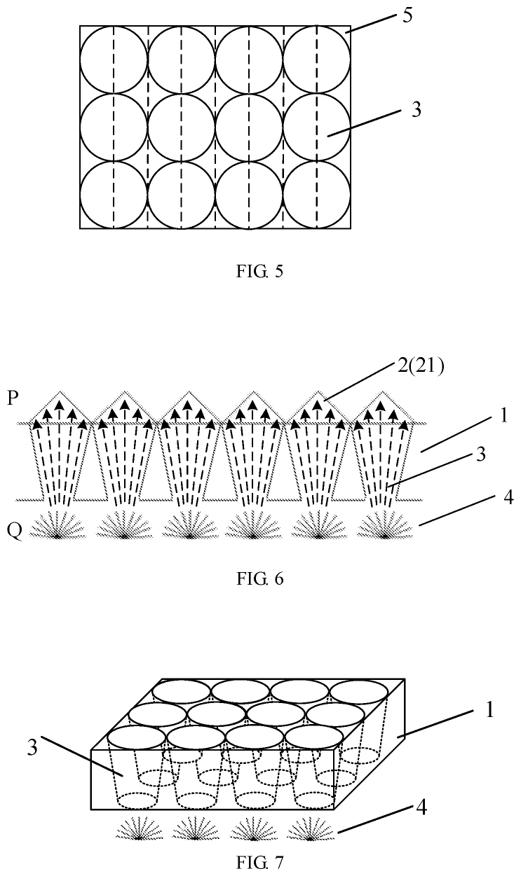

FIG. 5 is a schematic diagram of another arrangement mode of the holes 3 in the base layer 1 of the prism sheet provided by some embodiments of the present disclosure. For example, the area between two adjacent dashed lines in FIG. 5 corresponds to the bottom surface 5 of one prism 21. In the example as shown in FIG. 5, each hole 3 corresponds to a plurality of prisms 21 (e.g., two prisms 21), so that each hole 3 can cover the plurality of prisms 21. Because a size of an individual prism 21 of the prism layer 2 is small and usually at the nanometer level, this arrangement mode expands an aperture of the individual hole 3, reduces the difficulty of forming holes in the base layer 1, i.e., simplifies the opening process.

FIGS. 4 and 5 above are only exemplary illustrations, in practical applications, users can set the opening method in the base layer (specifically including the distribution method, distribution density, number, and shape of the holes 3 in the base layer 1, etc.) according to requirements, and the embodiments of the present disclosure are not specifically limited to this case.

FIG. 6 is a longitudinal sectional schematic diagram of a prism sheet provided by some embodiments of the present disclosure; and FIG. 7 is a perspective structural schematic diagram of a base layer of a prism sheet provided by some embodiments of the present disclosure.

As can be seen from FIG. 6, because the light emitted from the surface light source 4 is not transmitted in a single direction (e.g., a direction perpendicular to the bottom surface of the prism 21), but diverges in various directions, in order to enable the light entering the holes 3 to be transmitted to the prism layer 2 through the holes 3 as much as possible, for example, the area of the end surface, which is close to the first side P of the base layer 1, of each hole 3 is larger than the area of the end surface, which is close to the second side Q of the base layer 1, of each hole 3. That is, the area of the end surface of each hole 3 close to the prism layer 2 is larger than the area of the end surface of each hole 3 close to the light source 4. For example, the area of the end surface of the hole 3 parallel to the bottom surface 5 of the prism 21 gradually increase in a direction from the light source 4 to the prism layer 2.

For example, in some embodiments, the shapes of the holes 3 in the base layer 1 may be tapered shape (e.g., circular truncated cone shape, etc.), four pyramid shape, triangular pyramid shape, etc. For example, the shapes of all the holes 3 in the base layer 1 may be the same or may be at least partially different, and this present disclosure is not particularly limited to this case.

For example, as shown in FIGS. 6 and 7, in a case where the holes 3 are tapered holes, a radius of the end surface, which is close to the first side P of the base layer 1, of each hole 3 is larger than a radius of the end surface, which is close to the second side Q of the base layer 1, of each hole 3, that is, the radius of the end surface of each hole 3 close to the prism layer 2 is larger than the radius of the end surface of each hole 3 close to the light source 4. The holes 3 in the base layer 1 are formed to be tapered holes, so that part of the light emitted by the light source 4 can directly reach the prism layer 2 through the tapered holes 3, thereby avoiding the loss of the light caused by the base layer 1, further improving the light utilization rate, and further improving the display brightness of the display panel.

For example, in some implementations of the embodiments of the present disclosure, the radius of the end surfaces, which are close to the first side P (i.e., prism layer 2) of the base layer 1, of the tapered holes 3 range from 60 to 80 nanometers, while the radius of the end surfaces, which are close to the second side Q (i.e., light source 4) of the base layer 1, of the tapered holes 3 range from 30 to 40 nanometers.

In practical applications, the distance between two adjacent holes 3 in the base layer 1 is too small, which may lead to cracking and damage of the prism sheet. Therefore, the distance between any two adjacent holes 3 should not be less than 100 nm, that is, a minimum distance between the end surfaces, which are close to the light source 4, of any two adjacent holes 3 should not be less than 100 nm, for example, the minimum distance between the end surfaces, which are close to the second side Q of the base layer 1 (that is, the light source 4), of any two adjacent holes 3 is 100 nm. As shown in FIGS. 4 and 5, the minimum distance between the end surfaces of any two adjacent holes 3 close to the first side P (i.e., the prism layer 2) of the base layer 1 may be 0 nm. However, the embodiments of the present disclosure are not limited to this case, and the end surfaces of any two adjacent holes 3 close to the prism layer 2 may be arranged at intervals, that is, the minimum distance between the end surfaces of any two adjacent holes 3 close to the prism layer 2 is greater than 0 nm.

For example, in some embodiments, the number, shapes, etc. of the holes corresponding to each prism 21 are the same; and in other embodiments, the numbers and shapes of the holes corresponding to different prisms 21 may be different. For example, the prism layer 2 may include a first prism and a second prism, the first prism may correspond to one hole and the second prism may correspond to three holes. For example, the radius of the end surface, which is close to the first side P of the base layer 1, of the hole corresponding to the first prism is 60 nanometers, and the radius of the end surface, which is close to the second side Q of the base layer 1, of the hole corresponding to the first prism is 30 nanometers. The radius of each of the end surfaces, which are close to the first side P of the base layer 1, of the holes corresponding to the second prism is 80 nm, and the radius of each of the end surfaces, which are close to the second side Q of the base layer 1, of the holes corresponding to the second prism is 40 nm, that is, the hole corresponding to the first prism is larger than the holes corresponding to the second prism. The present disclosure dose not specifically limit the shapes, number, and the like of holes corresponding to each prism.

Similarly, in practical applications, users can set parameters, such as the shape, spacing, and size, of the holes 3 according to requirements. For example, the shape of the end surface of the hole 3 close to the prism layer 2 is not limited to the circle as shown in FIGS. 3-5, and may be any pattern, such as an ellipse, a rectangle, etc. Similarly, the shape of the bottom surface 5 of the prism 21 is not limited to the rectangle as shown in FIGS. 3-5, and may be any shape, such as a circle, a triangle, or the like.

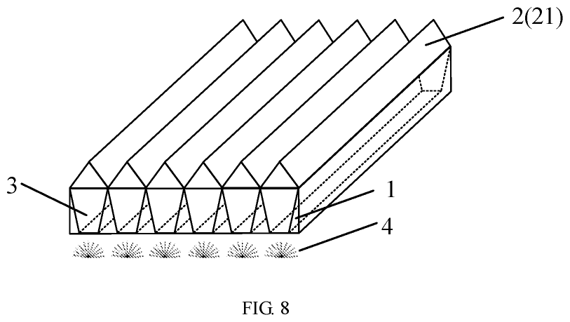

FIG. 8 is a perspective structural schematic diagram of another prism sheet provided by some embodiments of the present disclosure.

For example, in some embodiments, in a case where one hole 3 is provided at a position, corresponding to each prism 21, in the base layer 1, the end surface, which is close to the prism layer 2, of the hole 3 corresponding to one prism 21 coincides with the bottom surface 5 of the prism 21. For example, the end surface, which is close to the prism layer 2, of the hole 3 corresponding to the prism 21 may completely coincide with the bottom surface 5 of the prism 21, so as to allow more light to pass through the hole 3 to reach the prism layer 2, further reducing light loss. For example, as shown in FIG. 8, there is only one hole 3 in the base layer 1 corresponding to one prism 21. The end surface, which is close to the prism layer 2, of the hole 3 completely coincides with the bottom face 5 of the prism 21, i.e. the end surface, which is close to the prism layer 2, of the hole 3 is rectangular, and in this case, the hole 3 is formed into a groove structure. The end surface of the hole 3 close to the light source 4 is also rectangular. A length of the rectangular end surface, which is close to the prism layer 2, of the hole 3 is equal to a length of the rectangular end surface, which is close to the light source 4, of the hole 3, but a width of the rectangular end surface, which is close to the prism layer 2, of the hole 3 is larger than a width of the rectangular end surface, which is close to the light source 4, of the hole 3, so that a longitudinal section of the groove structure (i.e., a section perpendicular to the bottom surface 5 of the prism 21) presents a trapezoidal shape, such a structure enables more light to enter the prism layer 2 through the hole 3, and at the same time enables the distribution of the light entering the same prism 21 to be more uniform.

It should be noted that in the embodiment of the present disclosure, the term that “the end surface, which is close to the prism layer 2, of the hole 3 coincides with the bottom surface 5 of the prism 21” may indicate that the end surface, which is close to the prism layer 2, of the hole 3 is located within the bottom surface 5 of the prism 21.

For example, in other embodiments, in a case where at least two holes 3 are provided at a position, corresponding to each prism 21, in the base layer 1, end surfaces, which are close to the prism layer 2, of the at least two holes 3 corresponding to one prism 21 coincide with the bottom surface 5 of the prism 21, for example, as shown in FIG. 3, each prism 21 corresponds to three holes 3, and the end surfaces, which are close to the prism layer 2, of the three holes 3 are all located in the bottom surface 5 of the prism 21, that is, do not exceed the bottom surface 5 of the prism 21. For example, in some embodiments, the bottom surface of the prism 21 may be rectangular, the end surface, which is close to the prism layer 2, of each hole 3 is also rectangular, and the end surfaces, which are close to the prism layer 2, of at least two holes 3 corresponding to the prism 21 may completely coincide with the bottom surface 5 of the prism 21.

A comparison experiment is performed between the prism sheet (hereinafter referred to as the first prism sheet) in the comparative example and the prism sheet (hereinafter referred to as the second prism sheet) provided in the embodiment of the present disclosure. The first prism sheet may be the prism sheet as shown in FIG. 2, and the first prism sheet used in this experiment is a 10.1 inch prism sheet, a length of the first prism sheet is 219.05 mm, a width of the first prism sheet is 137.36 mm, and a thickness of the first prism sheet is 0.102 mm (the thickness of the base layer 10 of the prism sheet as shown in FIG. 2 is 0.075 mm, and the height of the prism layer 20 is 0.027 mm); and the second prism sheet according to the embodiment of the present disclosure is obtained by forming holes 3 in a 10.1 inch first prism sheet, a length, a width, and a thickness of the second prism sheet are the same as the length, the width and the thickness of the first prism sheet. A structure of the second prism sheet used in this experiment is as shown in FIG. 3, and the radius (denoted as a first radius) of the end surface, which is close to the prism layer 2, of a hole 3 is 80 nm, and the radius of the end surface, which is close to the light source 4, of the hole 3 is 40 nm. The number of the holes (i.e., the number of the holes 3 corresponding to each prism 21 is about 14*10⁵) can be calculated according to the length of each prism 21 and the first radius of the hole.

Gain measurement of the prism sheet: an optical gain of the first prism sheet and an optical gain of the second prism sheet of the embodiment of the present disclosure are respectively measured, the optical gain of the first prism sheet is 1.58 and the optical gain of the second prism sheet is 1.82, a brightness of the second prism sheet of the embodiment of the present disclosure is increased by 15.1% compared with a brightness of the first prism sheet, and the detailed comparison is shown in Table 1.

The RA reliability experiment is performed on the first prism sheet and the second prism sheet, and the specific steps are as follows: the first prism sheet and the second prism sheet are put in a 150° C. high-temperature precision experiment machine for 30 minutes and then taken out, and size parameters of the first prism sheet and size parameters the second prism sheet are respectively measured. After high temperature, the length of the first prism sheet is changed from 219.05 mm to 221.503 mm, the width of the first prism sheet is changed from 137.36 mm to 137.827 mm, and a longitudinal elongation rate and a transverse elongation rate of the first prism sheet are 1.12% and 0.34% respectively. After high temperature, the length of the second prism sheet is changed from 219.06 mm to 219.643 mm, the width of the second prism sheet is changed from 137.38 mm to 137.465 mm, and a longitudinal elongation rate and a transverse elongation rate of the second prism sheet are 0.28% and 0.085% respectively. The detailed comparison is shown in Table 1.

TABLE 1

| | | | RA experiment | | | | | |
|---|---|---|---|---|---|---|---|---|
| | | | before the experiment | | after the experiment | | longitudinal | transverse |
| | | gain | length/ | width/ | length/ | width/ | elongation | elongation |
| | gain | enhancement/% | mm | mm | mm | mm | rate/% | rate/% |
| first prism | 1.58 | 15.1 | 219.05 | 137.36 | 221.503 | 137.827 | 1.12 | 0.34 |
| sheet | | | | | | | | |
| second prism | 1.82 | | 219.06 | 137.38 | 219.643 | 137.465 | 0.27 | 0.062 |
| sheet | | | | | | | | |

According to the above comparative experiments, it can be know that, compared with the first prism sheet in the comparative example, the prism sheet (i.e., the second prism sheet) of the embodiment of the present disclosure can effectively reduce the light loss caused by light passing through the base layer of the prism sheet, improve the optical gain of the prism sheet, and further improve the overall brightness of the backlight source; and on the other hand, because the holes 3 are distributed in the base layer 1, the internal stress of the prism sheet is released, so that the prism sheet can generate smaller deformation in extreme environment, thereby improving the reliability and stability of the prism sheet, and ensuring the stability of light, which is output.

Based on the same inventive concept, some embodiments of the present disclosure also provide a backlight module, and the backlight module includes a light source 4 and a prism sheet, the prism sheet is the prism sheet described in any one of the above embodiments, and the light source 4 is used to provide light for the prism sheet. The light source 4 is located on a side of the base layer 1 away from the prism layer 2, that is, the light source 4 may be located on the second side Q of the base layer 1 of the prism sheet.

For example, taking the prism sheet as shown in FIG. 1A as an example, as shown in FIG. 1A, the prism sheet includes a base layer 1 and a prism layer 2 attached to a surface of a first side Q of the base layer 1, and holes 3 are provided inside the base layer 1 so that light emitted from a light source 4 on a second side Q of the base layer 1 reaches the prism layer 2 through the holes 3.

The base layer of the prism sheet in the backlight module is generally made of PET and other base materials, and has a certain attenuation effect on the light passing through the base layer. In the backlight module provided by the embodiment of the present disclosure, at least part of the light emitted by the light source 4 can reach the prism layer 2 through the holes 3 by forming the holes 3 in the base layer 1 of the prism sheet, thus reducing the light loss caused by the light passing through the base layer 1 of the prism sheet, further improving the light transmission efficiency of the light source 4, improving the overall brightness of the backlight module on the premise of not increasing the number of light bars in the light source, and helping to reduce the power consumption and thickness of the backlight module. On the other hand, because the holes 3 are distributed in the base layer 1, the internal stress of the prism sheet is released, so that the prism sheet is not easy to deform in extreme environments, the quality of the prism sheet is improved, and the light output by the backlight module is more uniform and stable.

For example, the light source 4 may be a light-emitting diode light source, that is, the light source 4 may include a plurality of light-emitting units arranged in an array, for example, the plurality of light-emitting units include red light units (R), green light units (G), and blue light units (B). These light-emitting units are light-emitting diodes (LEDs), such as inorganic LEDs or organic LEDs.

For example, the light source 4 may be a surface light source and includes a direct type light source and a side entry type light source. In a case where the light source 4 is a side entry type light source, the light source 4 includes a light-emitting unit and a light guide plate, the light guide plate may be located on the second side Q of the base layer 1, and the light-emitting unit may be located on a side adjacent to both the first side P of the base layer 1 and the second side Q of the base layer 1. It is worth noting that in a case where the light source 4 is a side entry type light source, a density of the holes on a side of the base layer close to the light-emitting unit of the light source 4 may be smaller than a density of the holes on a side of the base layer away from the light-emitting unit of the light source 4.

It should be noted that for the detailed description of the prism sheet in the backlight module, reference may be made to the related description in the above-mentioned embodiment of the prism sheet, and the repetition will not be repeated here again.

Based on the same inventive concept, some embodiments of the present disclosure also provide a display. For example, the display may include the backlight module described in any one of the above embodiments. The backlight module includes a light source and a prism sheet, taking the prism sheet as shown in FIG. 1A as an example, the prism sheet includes a base layer 1 and a prism layer 2 attached to a surface of a first side P of the base layer 1, and holes 3 are provided inside the base layer 1, so that light emitted from the light source 4 located on a second side Q of the base layer 1 reaches the prism layer 2 through the holes 3.

For example, the light source 4 may be located on a side, away from the prism layer 2, of the base layer 1 in the prism sheet.

The base layer of the prism sheet in the backlight module of the display is generally made of PET and other base materials, and has a certain attenuation effect on light passing through the base layer. In the display provided by the embodiment of the present disclosure, through providing the holes 3 in the base layer 1 of the prism sheet in the backlight module, at least part of the light emitted by the light source 4 can reach the prism layer 2 through the holes 3, thus reducing the light loss caused by the light passing through the base layer 1 of the prism sheet, further improving the light transmission efficiency of the light source 4, improving the overall brightness of the backlight module on the premise of not increasing the number of light bars of the light source, helping to reduce the power consumption and thickness of the backlight module, and improving the brightness of the display under condition of the same thickness and power consumption. On the other hand, because the holes 3 are distributed in the base layer 1, the internal stress of the prism sheet is released, so that the prism sheet is not easy to deform in extreme environments, the quality of the prism sheet is improved, the light output by the backlight module is more uniform and stable, and the display effect of the display panel is improved.

For example, the display also includes a display panel, and the backlight module is used to provide a light source for the display panel. For example, the display panel may be a rectangular panel, a circular panel, an oval panel, a polygonal panel, or the like. For example, the display panel may also have a touch function, that is, the display panel may be a touch display panel.

For example, the display can be any product or component with display function, such as mobile phone, tablet computer, television, notebook computer, digital photo frame, navigator, etc.

It should be noted that for the detailed description of the backlight module, reference may be made to the related description in the above-mentioned embodiment of the backlight module, and the repetition will not be repeated here again. It should be noted that other components of the display should be understood by those of ordinary skill in the art, and are not described in detail herein again, nor should they be taken as limitations on the present disclosure.

Based on the same inventive concept, some embodiments of the present disclosure also provide a preparation method for preparing the prism sheet. For example, the preparation method may include providing the base layer and preparing the holes inside the base layer of the prism sheet, so that the light received from the second side of the base layer reaches the prism layer through the holes.

For example, the holes can be prepared in the base layer by laser processing.

For example, the preparation method of the prism sheet provided by the embodiment of the present disclosure further comprises: coating a curable adhesive on the base layer provided with the holes or the prism layer, and curing the curable adhesive to obtain the prism sheet. That is, the prism layer 2 and the base layer 1 provided with the holes are combined into a whole through the curable adhesive.

For example, the curable adhesive may be a light curable adhesive (e.g., ultraviolet curable adhesive), a thermal curable adhesive, a cold curable adhesive, etc. In a case where the curable adhesive is the ultraviolet curable adhesive, after the ultraviolet curable adhesive is coated on the base layer or the prism layer, the base layer and the prism layer can be irradiated with an ultraviolet light to cure the ultraviolet curable adhesive; and in a case where the curable adhesive is a thermal curable adhesive, after the thermal curable adhesive is coated on the base layer or the prism layer, the thermal curable adhesive can be cured by applying a certain temperature (e.g., curing temperature) to the base layer and the prism layer.

It is worth noting that the base layer and the prism layer can also be integrated into a whole by an imprinting technology (e.g., nano-imprinting technology, etc.).

It should be noted that the structure, number, and arrangement manner of the holes in the base layer can refer to the related description of the holes in the above-mentioned embodiment of the prism sheet, and the repetition will not be repeated here again.

In the preparation method of the prism sheet provided by the embodiment of the present disclosure, the holes 3 are prepared in the base layer 1 at positions corresponding to the prisms 21 of the prism layer, so that at least part of the light emitted by the light source 4 can reach the prism layer through the holes 3, and compared with the prism sheet as shown in FIG. 2, the prism sheet prepared in the embodiment of the present disclosure reduces the light loss caused by the light passing through the base layer 1, thereby increasing the light transmittance and further improving the overall brightness of the display panel. On the other hand, because the holes 3 are distributed in the base layer 1, the internal stress of the prism sheet is released, and the deformation of the prism sheet in extreme environment is small, thus improving the reliability and stability of the prism sheet and ensuring the stability of output light.

For the present disclosure, the following points need to be explained:

(1) The drawings of the embodiments of the present disclosure only refer to the structures related to the embodiments of the present disclosure, and other structures may refer to the general design.

(2) In case of no conflict, the embodiments of the present disclosure and the features in the embodiments can be combined with each other to obtain new embodiments.

What are described above are only a part of the implementations of the present disclosure, and it should be pointed out that for those of ordinary skill in the art, several improvements and embellishments can be made under the premise of not departing from the principles of the present disclosure, and these improvements and embellishments should also be regarded as the protection scope of the present disclosure.

1. A prism sheet, comprising: a base layer and a prism layer on a surface of a first side of the base layer,
wherein holes are provided inside the base layer, so that light received from a second side of the base layer reaches the prism layer through the holes, and the first side of the base layer and the second side of the base layer are opposite to each other.

2. The prism sheet according to claim 1, wherein the prism layer comprises a plurality of prisms, and at least one hole is provided at a position, corresponding to each prism of the plurality of prisms, in the base layer.

3. The prism sheet according to claim 1 wherein in a case where one hole is provided at the position, corresponding to each prism, in the base layer, an end surface, which is close to the prism layer, of a hole corresponding to a prism coincides with a bottom surface of the prism.

4. The prism sheet according to claim 3, wherein the end surface, which is close to the prism layer, of the hole corresponding to the prism completely coincides with the bottom surface of the prism.

5. The prism sheet according to claim 1 wherein in the case where at least two holes are provided at the position, corresponding to each prism, in the base layer, end surfaces, which are close to the prism layer, of at least two holes corresponding to a prism coincide with a bottom surface of the prism.

6. The prism sheet according to claim 5, wherein the end surfaces, which are close to the prism layer, of the at least two holes corresponding to the prism completely coincides with the bottom surface of the prism.

7. The prism sheet according to claim 1, wherein at least one of the holes is a blind hole, and an opening of the blind hole is on the first side of the base layer or on the second side of the base layer.

8. The prism sheet according to claim 1, wherein an area of an end surface, which is close to the first side of the base layer, of each of the holes is larger than an area of an end surface, which is close to the second side of the base layer, of each of the holes.

9. The prism sheet according to claim 1, wherein each of the holes is a tapered hole, and a radius of an end surface, which is close to the first side of the base layer, of each of the holes is larger than a radius of an end surface, which is close to the second side of the base layer, of each of the holes.

10. The prism sheet according to claim 9, wherein the radius of the end surface, which is close to the first side of the base layer, of each of the holes ranges from 60 to 80 nanometers, and the radius of the end surface, which is close to the second side of the base layer, of each of the holes ranges from 30 to 40 nanometers.

11. The prism sheet according to claim 1, wherein a distance between end surfaces, which are close to the second side of the base layer, of any two adjacent holes is not less than 100 nanometers.

12. A backlight module, comprising: a light source and a prism sheet,
wherein the light source is configured to provide the light for the prism sheet,
the prism sheet comprises: a base layer and a prism layer on a surface of a first side of the base layer, holes are provided inside the base layer, so that light received from a second side of the base layer reaches the prism layer through the holes, and the first side of the base layer and the second side of the base layer are opposite to each other.

13. The backlight module according to claim 12, wherein the light source is on the second side of the base layer of the prism sheet.

14. The backlight module according to claim 12, wherein the light source is a light-emitting diode light source.

15. A display, comprising the backlight module according to claim 12.

16. A preparation method of a prism sheet, wherein the prism sheet comprises: a base layer and a prism layer on a surface of a first side of the base layer, holes are provided inside the base layer, so that light received from a second side of the base layer reaches the prism layer through the holes, and the first side of the base layer and the second side of the base layer are opposite to each other,
the preparation method comprises:
preparing the holes in the base layer of the prism sheet, so that the light received from the second side of the base layer reaches the prism layer through the holes.

17. The preparation method according to claim 16, further comprising:
coating a curable adhesive on the base layer provided with the holes or the prism layer, and curing the curable adhesive.

18. The preparation method according to claim 17, wherein the curable adhesive is an ultraviolet curable adhesive.

19. The prism sheet according to claim 2, wherein an area of an end surface, which is close to the first side of the base layer, of each of the holes is larger than an area of an end surface, which is close to the second side of the base layer, of each of the holes.

20. The prism sheet according to claim 2, wherein each of the holes is a tapered hole, and a radius of an end surface, which is close to the first side of the base layer, of each of the holes is larger than a radius of an end surface, which is close to the second side of the base layer, of each of the holes.
